(19) United States
(12) Patent Application Publication
(10) Pub. No.: US 2007/0168509 A1
(43) Pub. Date: Jul. 19, 2007

(54) System and method for remote loading of classes

(76) Inventors: Mladen I. Droshev, Sofia (BG); Georgi N. Stanev, Sofia (BG)

Correspondence Address: SAP/BLAKELY, 12400 WILSHIRE BOULEVARD, SEVENTH FLOOR, LOS ANGELES, CA, 90025-1030, US

(21) Appl. No.: 11/323,063

(22) Filed: Dec. 30, 2005

(51) Int. Cl. G06F 15/173

(52) U.S. Cl. 709/225

(57) ABSTRACT

A system and method are described in which remote resources are transmitted to a client. For example, the client may make a dynamic call to a remote server for a classloader and/or class and the server transmits the necessary classloader and/or class to the client.

### BACKGROUND

1. Field of the Invention

This invention relates generally to the field of data processing systems. More particularly, the invention relates to a system and method for improving the efficiency of remote method invocations (“RMI”) within a multi-tiered enterprise network.

2. Description of the Related Art

### Multi-Tier Enterprise Computing Systems

Java 2 Enterprise Edition (“J2EE”) is a specification for building and deploying distributed enterprise applications. Unlike traditional client-server systems, J2EE is based on a multi-tiered architecture in which server side program code is divided into several layers including a “presentation” layer and a “business logic” layer.

FIG. 1a illustrates an exemplary J2EE application server 100 in which the presentation layer is implemented as a Web container 111 and the business layer is implemented as an Enterprise Java Bean (“EJB”) container 101. Containers are runtime environments which provide standard common services 119, 109 to runtime components. For example, the Java Naming and Directory Interface (“JNDI”) is a service that provides application components with methods for performing standard naming and directory services. Containers also provide unified access to enterprise information systems 117 such as relational databases through the Java Database Connectivity (“JDBC”) service, and legacy computer systems through the J2EE Connector Architecture (“JCA”) service. In addition, containers provide a declarative mechanism for configuring application components at deployment time through the use of deployment descriptors (described in greater detail below).

As illustrated in FIG. 1a, each layer of the J2EE architecture includes multiple containers. The Web container 111, for example, is itself comprised of a servlet container 115 for processing servlet and a Java Server Pages (“JSP”) container 116 for processing Java server pages. The EJB container 101 includes three different containers for supporting three different types of enterprise Java beans: a session bean container 105 for session beans, an entity bean container 106 for entity beans, and a message driven bean container 107 for message driven beans. A more detailed description of J2EE containers and J2EE services can be found in RAGAE GHALY AND KRISHNA KOTHAPALLI, SAMS TEACH YOURSELF EJB IN 21 DAYS (2003) (see, e.g., pages 353-376).

Session beans are objects which represent the high level workflow and business rules implemented by the application server 100. For example, in a customer relationship management (“CRM”) system, session beans define the business operations to be performed on the underlying customer data (e.g., calculate average customer invoice dollars, plot the number of customers over a given timeframe, . . . etc). Session beans typically execute a single task for a single client during a “session.” Two versions of session beans exist: “stateless” session beans and “stateful” session beans. As its name suggests, a stateless session bean interacts with a client without storing the current state of its interaction with the client. By contrast, a stateful session bean stores its state across multiple client interactions.

Entity beans are persistent objects which represent data (e.g., customers, products, orders, . . . etc) stored within a relational database. Typically, each entity bean is mapped to a table in the relational database and each “instance” of the entity bean is typically mapped to a row in the table (referred to generally as an “object-relational mapping”). Two different types of persistence may be defined for entity beans: “bean-managed persistence” and “container-managed persistence.” With bean-managed persistence, the entity bean designer must provide the code to access the underlying database (e.g., SQL Java and/or JDBC commands). By contrast, with container-managed persistence, the EJB container 101 manages the underlying calls to the database.

Each enterprise Java bean (“EJB”) consists of “remote home” and/or “local home” interfaces and “remote component” and/or “local component” interfaces, and one class, the “bean” class. The home interfaces list the methods available for creating, removing and finding EJBs within the EJB container. The home object is the implementation of the home interface and is generated by the EJB container at deploy time. The home object is used by clients to identify particular components and establish a connection to the components' interfaces. The component interfaces provides the underlying business methods offered by the EJB.

Remote clients access session beans and entity beans through the beans' remote interfaces, using a technique known as remote method invocation (“RMI”). Specifically, RMI allows Java objects such as EJBs to invoke methods of the remote interfaces on remote objects. Objects are considered “remote” if they are located within a different Java virtual machine (“JVM”) than the invoking object. The JVM may be located on a different physical machine or on the same machine as the JVM of the invoking object.

FIG. 1b illustrates an exemplary architecture in which a local object 150 on a virtual machine 155 invokes a remote method of a remote object 151 on a different virtual machine 156. Rather than communicating directly, the local object 150 and the remote object 151 communicate through “stubs” 160 and “skeletons” 161 to execute the remote methods. The stub 160 for a remote object 151 provides a local representation of the remote object 151. The stub 160 implements the same set of remote interfaces that the remote object implements.

When a stub's method is invoked, it initiates a connection with the skeleton 161 on the remote virtual machine 156 and transmits the parameters of the method to the skeleton 161. The skeleton 161 forwards the method call to the actual remote object 151, receives the response, and forwards it back to the stub 160. The stub 160 then returns the results to the local object 150.

A “tie” for a remote object is a server-side entity which is similar to a skeleton, but which communicates with the calling object using the Internet Inter-orb protocol (“IIOP”). Another well known transport protocol used to establish communication between stubs and skeletons is the P4 protocol developed by SAP AG. As used throughout the remainder of this document, the term “skeleton” is meant to include ties and any other objects which perform the same underlying functions as skeletons.

A “deployment descriptor” is an XML file (named “ejb-jar.xml”) that describes how a component is deployed within the J2EE application server 100 (e.g., security, authorization, naming, mapping of EJB's to database objects, etc). Because the deployment descriptor information is declarative, it may be changed without modifying the underlying application source code. At the time of deployment, the J2EE server 100 reads the deployment descriptor and acts on the application and/or component accordingly.

In a Java runtime environment a classloader loads classes needed by an object if the classes are available to the classloader. These classes are only loaded as necessary. In other words the classloader will no load classes in the system unless instructed to do so. Classloaders in Java are hierarchical in the sense that they follow parent-children relationships.

FIG. 2 illustrates the prior art flow in Java for a classloader to provide a requested class. A method (or object) calls 201 its classloader to load a needed class. The classloader first determines 203 if it has already loaded the class requested. If the class has been previously loaded and not garbage collected, the processing 205 continues with this class since it is available. If the class is not available, the classloader must try to find the class. Classloaders typically check 207 their parent classloader first to determine if the parent has access 209 to the class. If the parent has access, the class is loaded 211 the processing continues. If the parent does not have access it, the current classloader (the classloader called 201) searches 217 for the class in pre-determined locations. These locations are “programmed” into the classloader and are not changeable without updating the classloader. Updating the classloader requires a recompile of the classloader code and the complete stopping of the program executing. At 219, it is determined if the classloader has found the class. If the classloader has found the class, the class is loaded 223 and processing resumes. If the class is not found, an error is thrown 221 and the program executing terminates.

FIG. 3 illustrates an exemplary prior art flow for a client requesting a RMI from a server. The client initiates a RMI 301 to a server. Exemplary connection protocols for use between the client and the server include IIOP or P4. The server processes 303 the client's request with this remote resource and transmits 305 the result of this processing to the client. The server does not transmit the remote resource's associated files (for example, classes, assembly, classloader, etc.) that were required to process the request. Without these associated files the client cannot perform further processing on the transferred result. Every time the client would like to further process transferred result it must make the server in the form of a RMI request, wait for the server to process the request, and then receive the result of the processing from the server.

### SUMMARY

A system and method are described in which remote resources are transmitted to a client. For example, the client may make a dynamic call to a remote server for a classloader and/or class and the server transmits the necessary classloader and/or class to the client.

### BRIEF DESCRIPTION OF THE DRAWINGS

A better understanding of the present invention can be obtained from the following detailed description in conjunction with the following drawings, in which:

FIG. 1a illustrates an exemplary Java 2 Enterprise Edition architecture.

FIG. 1b illustrates the use of stubs and skeletons to enable communication between remote objects.

FIG. 2 illustrates the prior art flow in Java for a classloader to provide a requested class.

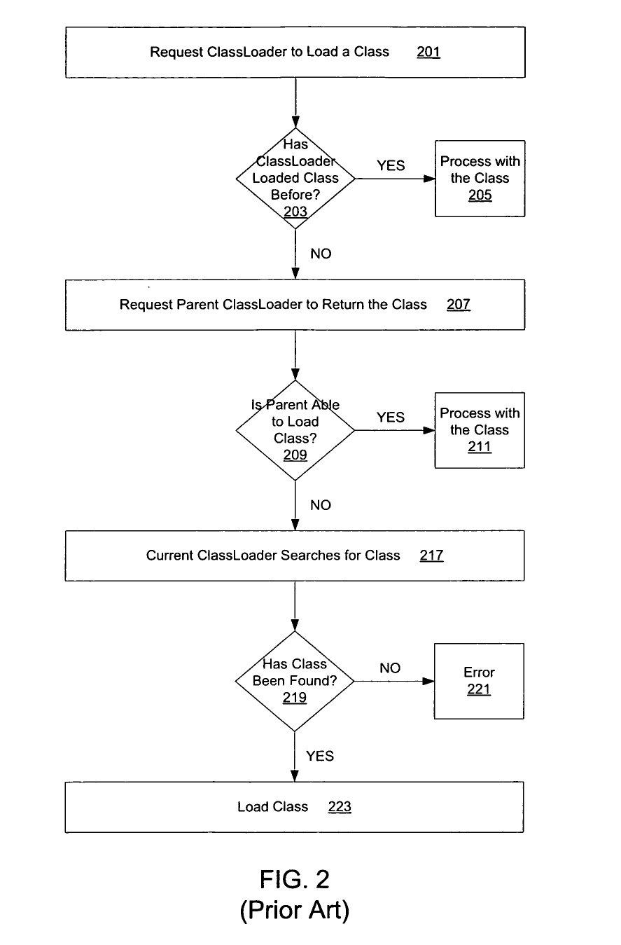

FIG. 3 illustrates an exemplary prior art flow for a client requesting a RMI from a server.

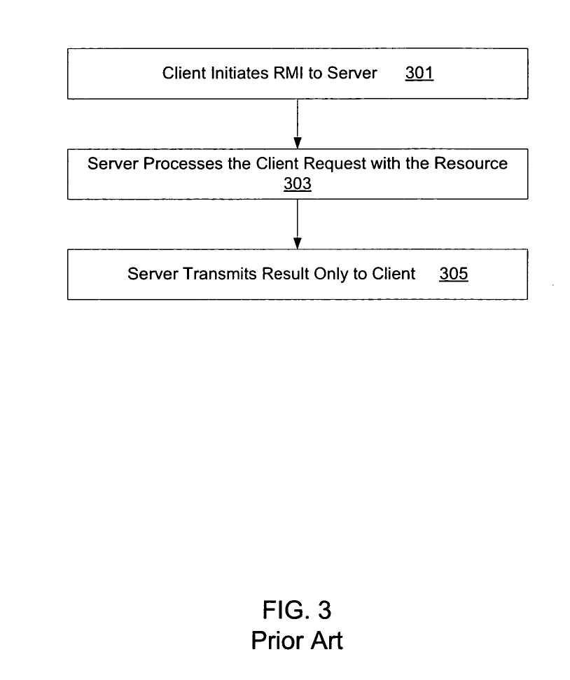

FIG. 4 illustrates an application server architecture on which embodiments of the invention may be implemented.

FIG. 5 illustrates a system architecture for implementing the embodiments of the invention described herein.

FIG. 6 illustrates a method according to one embodiment of the invention.

FIG. 7 illustrates a stub bound directly to a remote object as a consequence of implementing one embodiment of the invention.

FIG. 8 illustrates one embodiment of the invention for generating dynamic proxies and/or skeletons.

FIG. 9 illustrates a dynamic proxy generated in accordance with one embodiment of the invention.

FIG. 10 illustrates a method for generating dynamic proxies and/or skeletons in accordance with one embodiment of the invention.

FIG. 11 illustrates a system architecture on which embodiments of the invention may be implemented.

FIG. 12 illustrates a method according to one embodiment of the invention.

FIG. 13 illustrates a method according to one embodiment of the invention.

### DETAILED DESCRIPTION OF PREFERRED EMBODIMENTS

Described below is a system and method for improving the efficiency of classloading using remote method invocations (“RMI”) within a multi-tiered enterprise network. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

One embodiment of the invention transmits remote resources needed by a local client to the local client. For example, if the client does not have the necessary class and/or classloader to process an object, the client may make a RMI to a server (such as a J2EE engine) and the server may transmit the necessary class and/or classloader to the client if available.

### An Exemplary Cluster Architecture

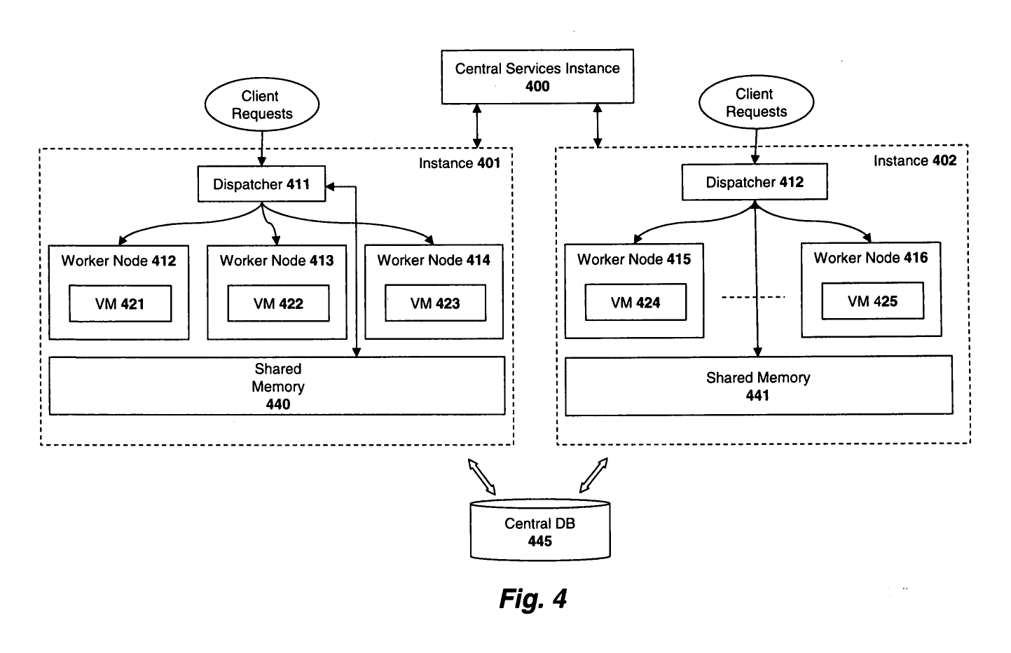

A system architecture on which embodiments of the invention may be implemented is illustrated in FIG. 4. The architecture includes a plurality of application server “instances” 401 and 402. The application server instances 401 and 402 each include a group of worker nodes 412-414 and 415-416 (also sometimes referred to herein as “server nodes”), respectively, and a dispatcher 411 and 412, respectively. The application server instances 401, 402 communicate through a central services instance 400 using message passing techniques. In one embodiment, the central services instance 400 includes a locking service and a massaging service (described below). The combination of all of the application server instances 401 and 402 and the central services instance 400 is referred to herein as a “cluster.” Although the following description will focus solely on instance 401 for the purpose of explanation, the same principles apply to other instances within the cluster.

The worker/server nodes 412-414 within instance 401 provide the business and/or presentation logic for the network applications supported by the system. Each of the worker nodes 412-414 within a particular instance may be configured with a redundant set of programming logic and associated data, represented as virtual machines 421-423 in FIG. 4. In one embodiment, the dispatcher 411 distributes service requests from clients to one or more of the worker nodes 412-414 based on the load on each of the servers. For example, in one embodiment, the dispatcher maintains separate queues for each of the 412-414 in a shared memory 440. The dispatcher 411 fills the queues with client requests and the worker nodes 412-414 consume the requests from each of their respective queues. The client requests may be from external clients (e.g., browser requests) or from other components/objects within the instance 401 or cluster.

In one embodiment, the worker nodes 412-414 may be Java 2 Enterprise Edition (“J2EE”) worker nodes which support Enterprise Java Bean (“EJB”) components and EJB containers (at the business layer) and Servlets and Java Server Pages (“JSP”) (at the presentation layer). In this embodiment, the virtual machines 421-425 implement the J2EE standard (as well as the additional non-standard features described herein). It should be noted, however, that certain high-level features described herein may be implemented in the context of different software platforms including, by way of example, Microsoft .NET platforms and/or the Advanced Business Application Programming (“ABAP”) platforms developed by SAP AG, the assignee of the present application.

In one embodiment, communication and synchronization between each of the instances 401, 402 is enabled via the central services instance 400. As mentioned above, the central services instance 400 includes a messaging service and a locking service. The message service allows each of the servers within each of the instances to communicate with one another via a message passing protocol. For example, messages from one server may be broadcast to all other servers within the cluster via the messaging service (e.g., such as the cache configuration messages described below). Alternatively, messages may be addressed directly to specific servers within the cluster (i.e., rather than being broadcast to all servers). In one embodiment, the locking service disables access to (i.e., locks) certain specified portions of configuration data and/or program code stored within a central database 445. The locking service locks data on behalf of various system components which need to synchronize access to specific types of data and program code. In one embodiment, the central services instance 400 is the same central services instance as implemented within the Web Application Server version 6.3 and/or 6.4 developed by SAP AG. However, the underlying principles of the invention are not limited to any particular type of central services instance.

In addition, unlike prior systems, one embodiment of the invention shares objects across virtual machines 421-425. Specifically, in one embodiment, objects such as session objects which are identified as “shareable” are stored within a shared memory region 440, 441 and are made accessible to multiple virtual machines 421-425. Creating new object instances from scratch in response to client requests can be a costly process, consuming processing power and network bandwidth. As such, sharing objects between virtual machine as described herein improves the overall response time of the system and reduces server load.

In a shared memory implementation, a shared memory area 440, 441 or “heap” is used to store data objects that can be accessed by multiple virtual machines 421-425. The data objects in a shared memory heap should generally not have any pointers or references into any private heap (e.g., the private memory regions/heaps of the individual virtual machines). This is because if an object in the shared memory heap had a member variable with a reference to a private object in one particular virtual machine, that reference would be invalid for all the other virtual machines that use that shared object.

More formally, this restriction can be thought of as follows: For every shared object, the transitive closure of the objects referenced by the initial object should only contain shared objects at all times. Accordingly, in one implementation of the invention, objects are not put into the shared memory heap by themselves—rather, objects (such as the session objects described herein) are put into the shared memory heap in groups known as “shared closures.” A shared closure is an initial object plus the transitive closure of all the objects referenced by the initial object.

### System and Method for Improving the Efficiency of Remote Method Invocations

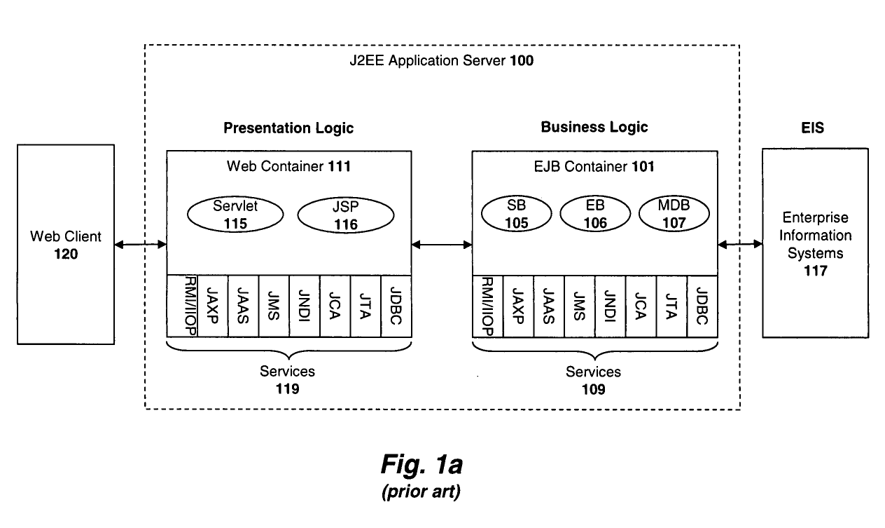

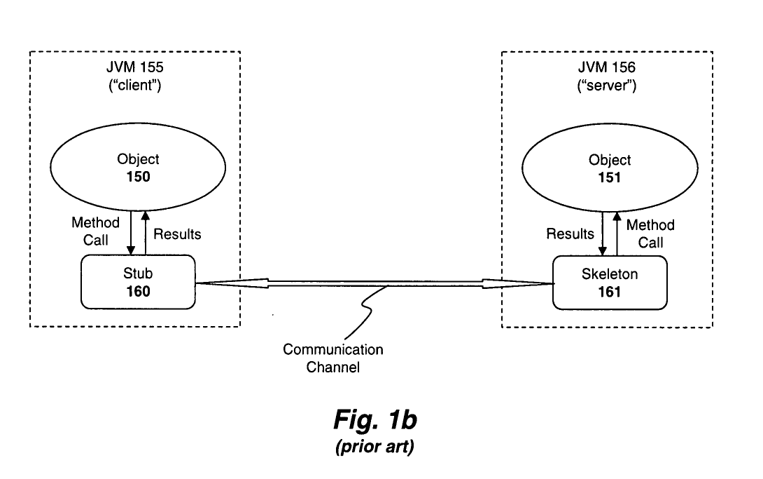

As described above with respect to FIG. 1b, stubs and skeletons are typically generated prior to deployment to enable communication between local and remote objects. However, when program code is developed it may not always be clear how related software components will be deployed. As a result, stubs and skeletons may be generated for objects even though those objects are eventually deployed on the same virtual machine and/or on the same physical machine. It would be more efficient under these conditions to remove the stubs and/or skeletons and to allow the local object, or the stub of the local object, to directly invoke methods from the “remote” object (which, of course, is not truly “remote” if it is located within the same virtual machine as the local object).

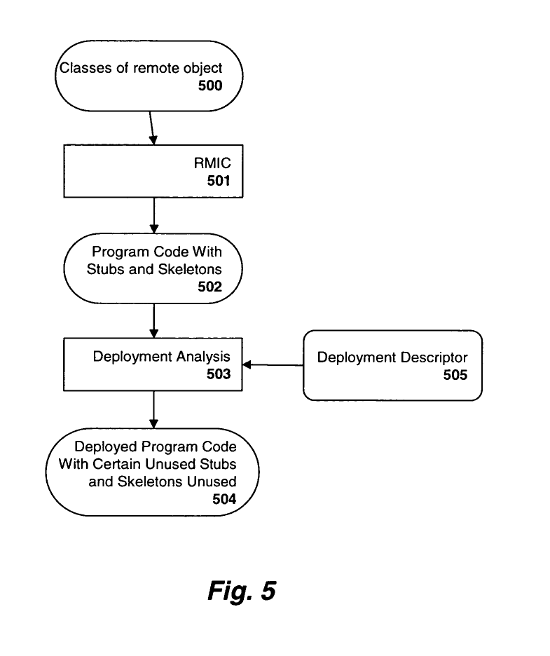

One embodiment of a system for addressing the foregoing issues is illustrated in FIG. 5. In this embodiment, a remote method invocation compiler (“RMIC”) is used to compile a remote class 500 to generate executable program code (e.g., classfiles) which contain stubs and skeletons. As described above, the RMIC compiler generates stubs and skeletons for objects which may be located on different virtual machines in the final deployment. For example, if a first object within a first application/component makes a method call to a second object within a different application/component, then a stub and skeleton may be generated by the RMIC compiler to enable communication between the two objects in the event that they are deployed within different virtual machines.

Unlike prior systems, however, the system shown in FIG. 5 includes a deployment analysis module 503 to block certain stubs and/or skeletons from being used, e.g., stubs/skeletons which are unnecessary because of the deployed location of the various application components. Returning to the previous example, if the deployment analysis module 503 detects that the first application/component and the second application/component are on the same virtual machine and/or physical machine, then it may block the skeleton and/or stub from being used and directly bind the first object (i.e., the invoking object) or the stub of the first object directly to the second object (i.e., the object on which a method is invoked).

In one embodiment, the deployment analysis module 503 will determine the deployed relationship between the two applications/components by parsing the deployment descriptor 505 for the applications/components. As mentioned above, the deployment descriptor 505 is an XML file which describes how code will actually be deployed within the application server. The end result is deployed code with certain stubs and/or skeletons removed 504.

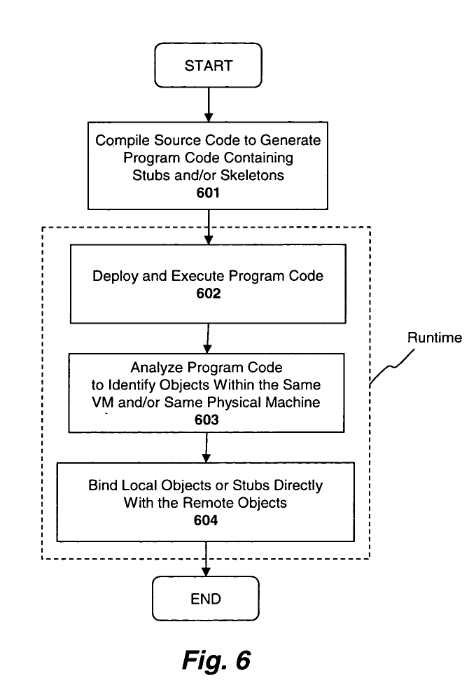

A method according to one embodiment of the invention is set forth in FIG. 6. At 601, source code is compiled, thereby generating program code containing stubs and skeletons. At 602, the modified program code is deployed and executed. At 603, the program code is analyzed in conjunction with the deployment descriptor to identify objects within the same virtual machine and/or physical machine. Finally, at 604, for any object which invokes a method of any other object within the same virtual machine or physical machine, the skeletons and/or stubs are blocked from being used by the system.

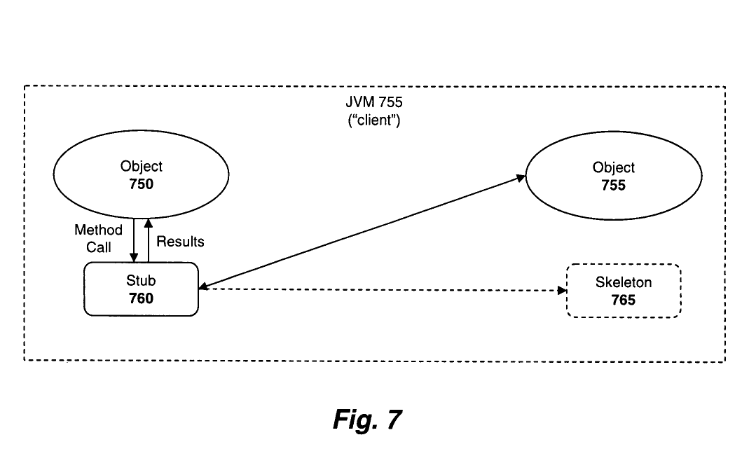

FIG. 7 illustrates the end result of one embodiment in which a skeleton 765 is left unused after it has been determined that the first object 750 and the second object 755 are located in the same virtual machine and/or the same physical machine. As a result, t; ie method call directed through the stub 760 is invoked directly on the second object 755.

### System and Method for Dynamic Proxy Generation

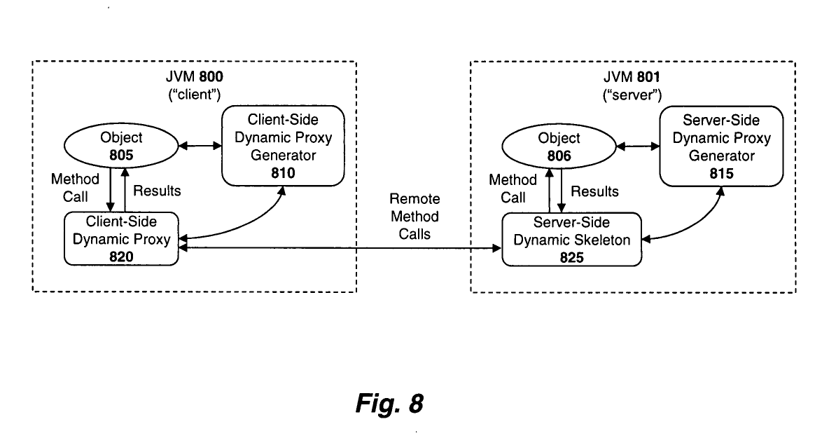

In addition to deleting unnecessary stubs and skeletons as described above, one embodiment of the invention analyzes method calls during runtime and dynamically generates client-side and/or server-side proxies to manage the method calls (i.e., in situations where no static stub and/or skeleton was generated prior to runtime). Specifically, referring to FIG. 8, in one embodiment, a client-side dynamic proxy generator 810 generates a client-side dynamic proxy 820 to handle remote method invocations upon detecting that no stub exists to handle the method invocations. In the illustrated example, a remote method invocation made by object 805 on virtual machine 800 is directed to a remote object 806 on another virtual machine 801. In addition, in one embodiment, a server-side dynamic skeleton generator 815 generates a server-side dynamic skeleton 825 to handle the remote method invocation upon detecting that no static skeleton exists.

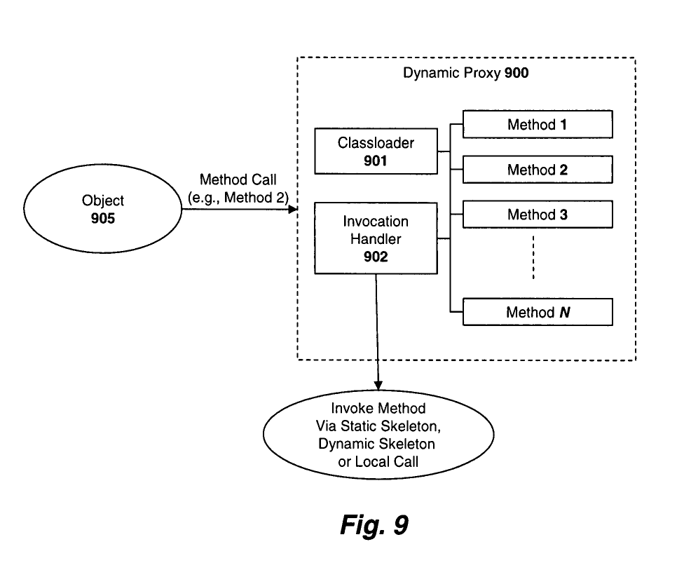

FIG. 9 provides additional details of an exemplary dynamic proxy 900. In one embodiment, the dynamic proxy 900 includes a plurality of method reference objects 1, 2, 3, . . . N, which correspond to the methods of the remote object. In one embodiment, the method reference objects are java.lang.ref objects which encapsulate a reference to the methods of the remote object. However, the underlying principles of the invention are not limited to any particular object types.

In operation, In response to receiving a method invocation to a remote object (in this case, a call to “method 2”) the dynamic proxy 900 initiates an invocation handler 902 to manage the remote method call. A classloader 901 finds the reference object that corresponds to the called method (i.e., Method 2) and wraps the method in the invocation handler object. The invocation handler 902 then uses the parameters of the method to make the remote method call via the static skeleton or the dynamic skeleton on the remote virtual machine. In addition, in one embodiment, if the method invocation is to a local object, then a “local” invocation handler is used to manage the local method call. Alternatively, the invocation handler may be bypassed altogether and the local method call may be made directly to the local object.

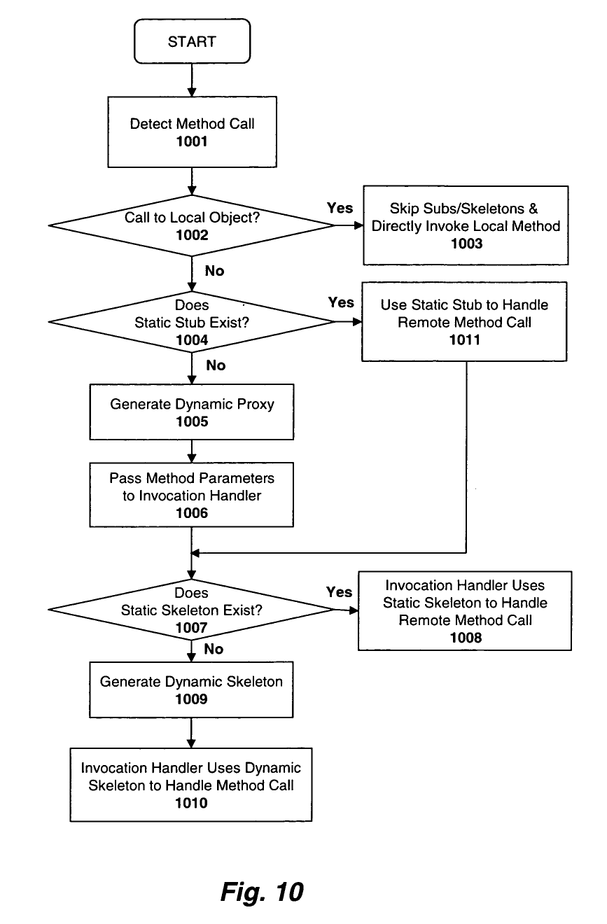

A method for generating dynamic proxies and skeletons according to one embodiment of the invention is set forth in FIG. 10. At 1001 a method call is detected on a local virtual machine. If the call is a local method call, determined at 1002, then at 1003 no dynamic stubs and/or skeletons are generated and the method invocation is made directly to the local object.

If, however, the call is to a remote object, then at 1004 a determination is made as to whether a static stub exists to handle the remote method invocation (i.e., a stub generated as a result of the RMIC compiler). If so, then at 1011, the stub is used to handle the remote method call. If not, then at 1005, a dynamic proxy such as that illustrated in FIG. 9 is generated on the local virtual machine to handle the remote method invocation. At 1006, the method parameters are passed to the invocation handler which manages the remote method call via the static skeleton or the dynamic skeleton on the remote virtual machine.

If no static skeleton exists on the remote virtual machine (i.e., if no skeleton was generated by the RMIC compiler), determined at 1007, then at 1009, a dynamic skeleton is generated to handle the remote method call and at 1010 the invocation handler communicates with the dynamic skeleton to process the remote method invocation. If a static skeleton already exists for the remote method, then at 1008, the invocation handler communicates with the static skeleton to invoke the remote method. In one embodiment, the invocation handler identifies the particular remote method and passes the dynamic or static skeleton the method parameters. The dynamic or static skeleton then directly invokes the method on the remote object using the method parameters and provides the results back to the invocation handler on the local virtual machine.

### An Exemplary Remote Classloading Architecture

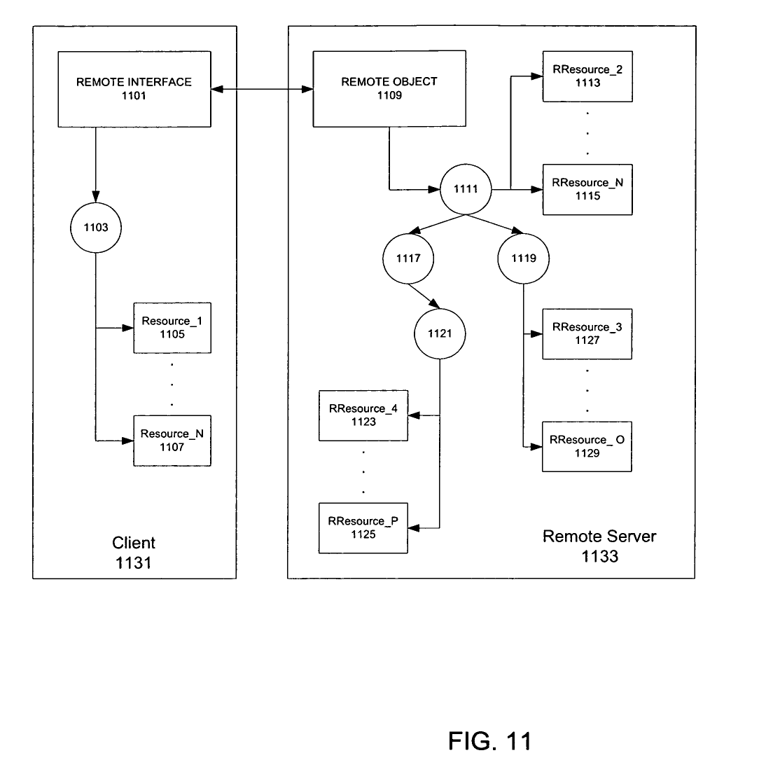

A system architecture on which embodiments of the invention may be implemented is illustrated in FIG. 11. The architecture includes a client 1131 and a remote server 1133. An exemplary remote server 1133 is a J2EE engine. The client includes a remote interface 1101, classloader 1103, and resources

The remote interface 1101 may communicate with a remote object

During a RMI, the remote interface 1101 to remote object 1109 connection is made using protocols such as Internet Inter-ORB Protocol (IIOP), P4, etc.

The classloader 1103 of the client has resources 1105,1107 such as JAR files, directories, and classes available to load related classes. For example, an application being processed by the client 1131 may call the classloader 1103 to load classes 1105 and 1107 which are in turn used by the application to process an object.

The remote server 1133 includes a remote object 1109 and in this example a plurality of classloaders 1111, 1117, 1119, 1121, and related resources 1113, 1115, 1123, 1125, 1127, 1129. Of course, it should be understood that the remote server 1133 or the client 1131 could have one ore more classloaders and resources related to each classloader. FIG. 11 also shows the parent-child relationship in classloaders. For example, classloader 1111 is the parent of classloaders 1117, 1119, 1121. Each of these child classloaders 1117, 1119, 1121 include their own resources.

During the execution of an application on client 1131 the client 1131 may need to call a classloader and/or class (or other resource) that is not available. The client 1131 calls on the server 1133 to get the needed classloader (or other resource). The server 1133 returns the associated class definition (or other resource) to the client so that the client may continue processing the application. By transmitting the class definition (or other resource) to the client 1131, the efficiency of the client 1131 is improved because the client will no longer have to rely on the server 1133 for processing when that classloader (or other resource) is needed.

### System and Method for Improving the Efficiency of Client Processing Using Remote Method Invocation

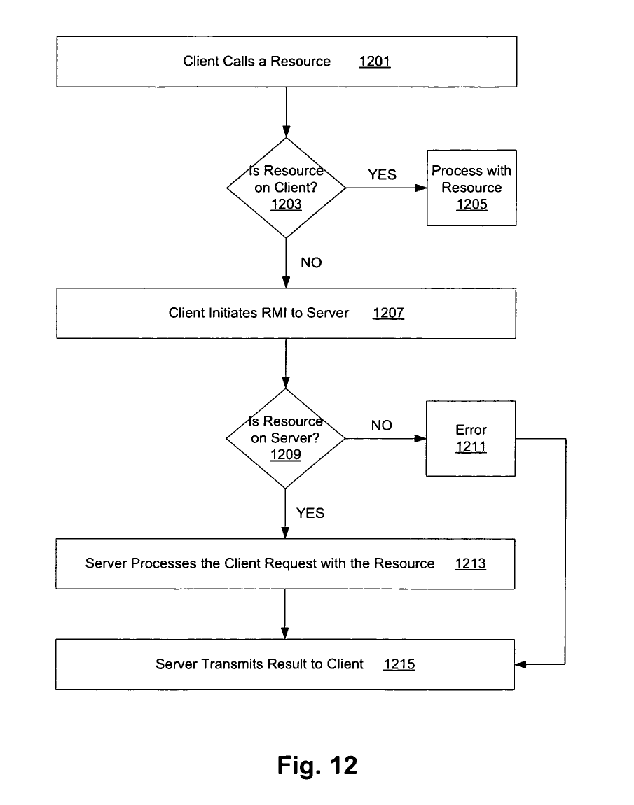

A method according to one embodiment of the invention is set forth in FIG. 12. During execution of a thread of a program, a client makes a call for a particular resource 1201. For example, the client may call for a classloader to load the necessary class(es) to process a particular object. At, 1203 it is determined if the client has the particular resource. If the client does have the resource it will continue the execution of the thread 1205. The resource may need to be loaded if it has not been used before on the client.

If the client does not have the resource it initiates a RMI to a remote server 1207. The server determines if the necessary resource is available on it at 1209. If the resource is not available, an error occurs 1211. If the resource is available, the server transmits the resource to the client 1213. The client continues executing the thread with the resource received from the server 1215. In another embodiment, the server processes the request with the resource and transmits both the result of the processing and the resource to the client. Exemplary resources transmitted to the client from the server include but are not limited to the classloader(s) and/or classes used by the server in processing the request. The client may also store (for example, cache) the resource for later use in an embodiment.

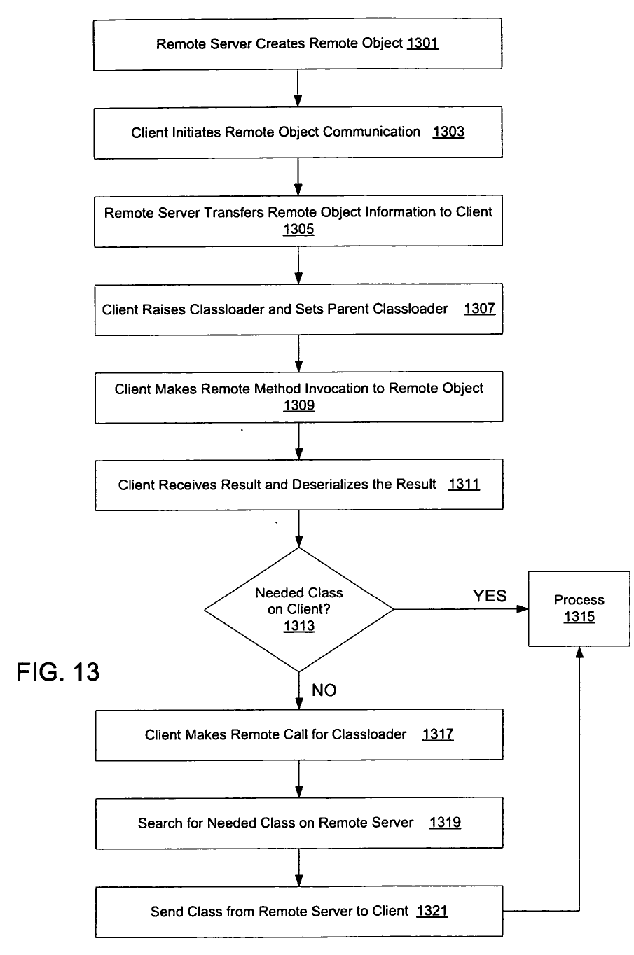

A method according to one embodiment of the invention is set forth in FIG. 13. At 1301, a remote object is created on a server. Information about the remote object including the name of the remote object's classloader is prepared to be sent to the client. At 1303, the client initiates communication with the remote object. The information prepared by the server at 1301 is sent to the client at 1305. This allows the client to identify the classloader(s) on the server.

At 1307, the client raises the RMI protocol's (for example, P4, IIOP, etc.) classloader and sets as the parent the client classloader. The client attempts RMI to the remote object at 1309. The client receives the serialized result from the RMI at 1311 and deserializes the result which is the value of the class. The classloader attempts to load this class.

During execution of a thread of a program on the client the client calls classloaders and associated classes when necessary. If the class is on the client, the thread is processed at 1315. If a class is not found on the client at 1313, the client makes a remote call to the server for the classloader and/or class that is needed. The client knows which classloader to call from the information sent at 1305. The remote call may be dynamically created as described with respect to FIG. 8. The server's classloader is searched for the client's needed classes at 1319. If the needed class is found, the class definition closure is sent to the client at 1321 and the client continues processing the thread with the class at 1315.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, although many of the embodiments set forth above relate to a Java or J2EE implementation, the underlying principles of the invention may be implemented in virtually any enterprise networking environment such as NET. Finally, it should be noted that the terms “client” and “server” are used broadly to refer to any applications, components or objects which interact via remote method invocations.

Accordingly, the scope and spirit of the invention should be judged in terms of the claims which follow.

What is claimed is:

1. A method comprising:
calling for a particular resource during execution of a program, wherein the calling is performed by a client;
determining if the client has the particular resource;
communicating with a server if the client does not have the particular resource; and
transmitting the particular resource to the client from the server.

2. The method of claim 1, wherein the particular resource is a classloader.

3. The method of claim 1, further comprising:
sending information from the server to the client regarding the resources available on the server.

4. The method of claim 1, wherein the communicating further comprises:
raising a remote method invocation dynamically to the server from the client.

5. The method of claim 1, further comprising:
caching the transmitted particular resource on the client.

6. The method of claim 1, further comprising:
deserializing the transmitted particular resource at the client.

7. The method of claim 6, further comprising:
loading the deserialized transmitted particular resource at the client; and
continuing execution with the resource.

8. A computing system comprising a machine, said computing system also comprising instructions disposed on a computer readable medium, said instructions capable of being executed by said machine to perform a method, said method comprising:
calling for a particular resource during execution of a program, wherein the calling is performed by a client;
determining if the client has the particular resource;
communicating with a server if the client does not have the particular resource; and
transmitting the particular resource to the client from the server.

9. The computing system of claim 8, wherein the particular resource is a classloader.

10. The computing system of claim 8, wherein said method further comprises:
sending information from the server to the client regarding the resources available on the server.

11. The computing system of claim 8, wherein the communicating further comprises:
raising a remote method invocation dynamically to the server from the client.

12. The computing system of claim 8, wherein said method further comprises:
caching the transmitted particular resource on the client.

13. The computing system of claim 8, wherein said method further comprises:
deserializing the transmitted particular resource at the client.

14. The computing system of claim 13, wherein said method further comprises:
loading the deserialized transmitted particular resource at the client; and
continuing execution with the resource.

15. An article of manufacture including program code which, when executed by a machine, causes the machine to perform a method, the method comprising:
calling for a particular resource during execution of a program, wherein the calling is performed by a client;
determining if the client has the particular resource;
communicating with a server if the client does not have the particular resource; and
transmitting the particular resource to the client from the server.

16. The article of manufacture of claim 15 wherein said executing further includes:
sending information from the server to the client regarding the resources available on the server.

17. The article of manufacture of claim 16, wherein the communicating further comprises:
raising a remote method invocation dynamically to the server from the client.

18. The article of manufacture of claim 15 wherein said executing further includes:
caching the transmitted particular resource on the client.

19. The article of manufacture of claim 15, wherein said executing further includes:
deserializing the transmitted particular resource at the client.

20. The article of manufacture of claim 19, wherein said executing further includes:
loading the deserialized transmitted particular resource at the client; and
continuing execution with the resource.
